(19) United States
(12) Patent Application Publication
(10) Pub. No.: US 2014/0361541 A1
(43) Pub. Date: Dec. 11, 2014

(54) Power Transfer Station

(71) Applicant: WINDDRIVE LIMITED, Tyne and Wear (GB)

(72) Inventor: Stephen Todd, Tyne and Wear (GB)

(21) Appl. No.: 14/355,395

(22) PCT Filed: Oct. 26, 2012
(86) PCT No.: PCT/GB2012/052676

§ 371 Date: Apr. 30, 2014

(30) Foreign Application Priority Data
Nov. 1, 2011 (GB) 1118863.8

(51) Int. Cl. F03D 9/02; F03D 3/00; F03D 9/00

(52) U.S. Cl. CPC F03D 9/028; F03D 9/001; F03D 3/005; F03D 9/002
USPC 290/44; 60/398; 60/413; 415/4.2; 60/327

(57) ABSTRACT

A power transfer system comprising a turbine for capturing wind energy; a plurality of driven devices which can be coupled to the turbine to be driven thereby; and a controller adapted to monitor a parameter relating to the energy output of the turbine and selectively load or unload one or more of the plurality of driven devices to maximise the efficiency of the turbine and maximise efficient power transfer from the turbine to one or more of the driven devices. The present invention efficiently power matches the available turbine energy with the energy capacity of the driven devices to thereby ensure the turbine and driven devices operate within an optimum range to minimise energy wastage and increase energy transfer efficiency.

The present invention generally relates to power transfer systems, and in particular to systems for efficiently capturing renewable energy and converting the same into usable energy for a consumer to offset their existing energy usage.

### INTRODUCTION

Power generators, such as wind turbines or water turbines, are known in the art for converting renewable energy, e.g. wind power or water power, into other forms of energy, such as electrical energy, mechanical work or compressed air. Typical applications include milling grain, pumping water or generating electricity. Wind powered systems in particular are becoming increasingly popular for direct or indirect wind power conversion and include horizontal axis wind turbines and vertical axis wind turbines.

However, the energy generated from wind power is usually highly variable due to its intermittency over time, making a short-term predictability of the available energy relatively difficult and its usability as a consistent energy provider is uncertain. For example, pumps and motors driven by the energy provided from the wind turbine may only be able to effectively use a narrow band of the potential energy range the wind turbine can provide between very high wind speeds and very low wind speeds. Therefore, potentially available wind energy is wasted because of the power mismatch between the turbine and driven devices. For example, the fluid pressure provided by a variable fluid pump that is directly driven by a wind turbine may not be enough to drive a motor or any other mechanical load having specific minimum energy requirements. On the other hand, at relatively high wind speeds, the motor or any other mechanical load may not be able to convert relatively high fluid pressure that is generated at relatively high wind speeds into usable work so that some of the energy in the pressurized fluid is undesirably wasted. The ability of the motor or pump, for example, to utilize energy may be limited by its construction or design, or such inability may be necessary to prevent damage to the same.

Furthermore, turbines have an optimal tip speed to wind speed ratio (TSR) which provides a maximum efficiency. The optimal TSR depends upon the turbine design, wind speed and wind direction. Lift based turbines generally do not keep the turbine in the optimal TSR as the electricity generating equipment is designed to operate efficiently at a fixed rpm so it is known to furl the blades as the wind speed increases to keep operating at the optimal RPM for the generator. However, this requires additional power and actuation means, which is generally complex, and results in a loss in efficiency. It would therefore be desirable to ensure the turbine operates within its most efficient TSR band.

Therefore, it is important to ‘match’ the power requirements of a driven device (i.e. the maximum amount of energy a motor, pump, heat exchanger or compressor, for example, can convert into usable work) with the current available energy (e.g. fluid flow, compressed air, mechanical work etc.) provided by the renewable energy generator (e.g. wind turbine), while ensuring the renewable energy generator is operating efficiently. This is also known as ‘power matching’ the energy load with the energy source in order to maximise the consumer's efficiency.

For example, it is known that the power output of a wind generator is proportional to the cube of the wind speed, i.e. as the wind speed doubles the power output increases by a factor of eight. This relationship is illustrated in FIG. 1, where the power output of a turbine is compared to the actual power used at different wind speeds. The graph in FIG. 1 clearly indicates the ‘mismatch’ between the used power utilised by a standard electricity turbine and the available power in the wind.

Accordingly, a requirement exists to improve the efficiency of a power transmission system and its energy loads. In particular, a requirement exists to provide a power transmission system for converting renewable energy into usable energy that can efficiently power match its energy load (i.e. utilized energy) to the currently available power provided from the highly variable renewable energy source, such as wind power or water power, in order to minimize wasted excess energy or energy that is insufficient to drive a load.

It is particularly important to operate a vertical axis turbine at its optimum TSR as the efficiency of the turbine quickly falls if the turbine is not operated at the correct speed when loaded.

### SUMMARY OF THE INVENTION

A first aspect of the present invention provides a power transfer system comprising:

a turbine for capturing wind energy;

a wind parameter measuring device for measuring at least one parameter of the wind adjacent said turbine;

at least one driven device coupleable to the turbine to be driven thereby; and

a controller adapted to monitor at least one turbine parameter relating to the energy output of the turbine and selectively load or unload one or more of the plurality of driven devices based on at least one said turbine parameter and at least one said wind parameter to maximise the efficiency of the turbine and the efficient power transfer from the turbine to one or more of the driven devices.

The rapid, selective and automatic loading or unloading of one or more of the driven devices based on one or more parameters relating to the energy output of the turbine desirably ensures the turbine operates efficiently and avoids any power mismatch between the turbine and the driven devices.

The controller can be programmed to take into account any buildings and/or other obstructions next to the turbine along with the position of individual measuring devices used to calculate the turbine optimum TSR based upon wind speed and/or direction.

When the turbine is operated in built up areas, where it may encounter accelerated gusting air flow, it is advantageous to be able to quickly adjust the load on the turbine to maintain optimum TSR and maximise capture of the available wind energy. In a built up environment the optimal TSR may change for a given turbine design, depending upon wind speed and direction, as the shape of accelerated air flow can change rapidly in such situations. A device measuring the local wind speed would not be able to measure the wind speed over the whole turbine. For example a wind measuring device located on the top of a turbine might show the same wind speed even if the wind is coming from two different directions but the actual wind speed across the length of a turbine could be different due to the effect of buildings or other obstructions. The optimum TSR over various wind speeds and directions for a given turbine design in a particular location will have to be identified by experimenting with the turbine in location. This data can then be used to programme the controller.

The invention ensures the number of driven devices being powered by the turbine and/or the loading of such devices is ‘matched’ to the energy available from the turbine at a point in time. Furthermore, the number of devices being driven and/or the level of loading on the devices can be ‘matched’ to the turbine to ensure it operates in its most efficient operating range. In other words, the invention not only ensures that the maximum available power taken by driven devices is “matched” with that from the turbine but also the controller ensures the turbine stays within its most efficient TSR band.

A parameter may suitably be wind speed, wind direction, turbine shaft rotational speed or torque and/or power output of the turbine.

The driven devices may comprise one or more of, or a combination of, an air compressor, a hydraulic pump, a heat pump for cooling or heating, and a liquid or gas pump, for example.

The driven devices may be directly or indirectly coupled to the turbine. For example, a direct drive may be used to power multiple air compressors. The compressors, for example, may suitably be connected in series to the turbine via a through drive shaft or independently via a multi-gearbox or a combination of the two. Other forms of driven devices, such as hydraulic pumps, may be coupled to the turbine in this way.

In the case of a through drive shaft, the air compressors may have an input shaft and an output shaft. The multiple compressors may be connected in line from the first compressor to the last via shaft couplings.

In a multi-gearbox arrangement, the multiple compressors may be powered by the multi-gearbox and may be connected to other compressors via a through drive.

Unloading one or more driven devices may be achieved by disengaging the drive from a driven device or, for example, by bypassing the drive to unload the device. Unloading a driven device may also be achieved by deactivating the device or reducing the load on it by, for example, opening a bypass valve connected to an air compressor or reducing the displacement of a hydraulic pump.

For example, the compressors may have bypass valves which allow them to vent the compressed air to atmosphere and thus take minimal power from the turbine.

Operation of the compressors in accordance with the present invention may be as follows. To start with, all compressors may be set to vent to air via corresponding bypass valves. The controller determines the rotational speed (rpm) of the turbine. The controller may also determine the wind speed and/or direction to determine the most efficient TSR at which to operate the turbine and thereby control the load on the turbine to ensure it operates at its most efficient for a particular wind speed and direction. As the turbine reaches a minimum rpm, for example, the controller selectively stops a first compressor venting to air by closing off its bypass valve and enables direct supply of compressed air to a customer's infrastructure, for example. When wind speed increases and a suitable rpm is determined by the controller, the controller actuates the bypass valves of additional compressors to enable additional supply of compressed air to the client's infrastructure. As the turbine rpm decreases, the controller determines the same and starts to unload appropriate compressors by opening their bypass valves until only one compressor is operating. If the rpm drops below the minimum system rpm, the final compressor is unloaded by opening its bypass valve.

The system advantageously allows the load to be rapidly increased or decreased as the torque generated by the turbine increases or decreases with actual wind speed seen by the turbine. This desirably ensures the turbine operates efficiently, power mismatch is minimised and efficient power transmission is achieved.

The system is specifically able to take advantage of potentially rapidly changing power captured by the turbine because it is used to directly power devices such as air compressors and water pumps which have a much wider range of efficient operation than those used to generate electricity.

The system may comprise disengagement means to selectively disengage the turbine from one or more driven devices. Such means may comprise a clutch. This would be desirable when a compressor is venting to air because, whilst being unloaded, it is still requiring approximately 10% of its operational power requirements. This means the turbine will be operating inefficiently even at lower wind speeds. A clutch arrangement operatively coupled with the controller could selectively disengage the turbine from one or more compressors to avoid this inefficiency.

Alternatively, a hydraulic system may be used to couple the turbine with the driven devices.

For example, one or more variable displacement hydraulic pumps may be coupled to the turbine to transfer the energy captured by the turbine to hydraulic fluid flow and pressure.

The hydraulic pumps may each comprise a bypass valve to allow them to selectively operate unloaded or partially loaded, as described above for air compressors. Additionally or alternatively, they may also have through drive systems, which enable them to be configured in multiple ways. Additionally or alternatively, the system may comprise a clutch to selectively disengage a pump from the turbine to avoid any inefficiencies of a bypass valve. The pumps may be placed at the top and bottom of a vertical axis turbine, for example.

The controller will monitor one or more parameter of the turbine, such as the rpm, wind speed, wind direction and/or energy provided by the turbine, and selectively vary the displacement of the pumps and/or the number of pumps loaded or unloaded to maximise the efficient power capture from the turbine and efficiently power match the same with the energy demand of the consumer. Hydraulic pumps can quickly and accurately alter the load on the turbine.

Suitably two variable displacement pumps may be coupled to a vertical axis wind turbine; one at the top of the turbine and one at the bottom. When the wind speed is relatively low, the primary hydraulic pump is used to draw power from the turbine. As the wind speed increases, the pump displacement is increased to ensure the turbine is capturing energy efficiently. At this stage the secondary hydraulic pump is not under full load and the hydraulic fluid is allowed to freely return to a hydraulic reservoir. Once the turbine reaches a certain speed for a given wind speed and direction, the power developed by the turbine has reached a certain amount then the secondary pump is utilised efficiently to generate hydraulic power into the system. The variable displacement of both pumps is controlled by the controller based on the turbine rotational speed, wind speed and direction to maximise overall efficiency.

The turbine may be operated in a built up environment next to a factory to directly supplement the factory's compressed air infrastructure. The building will accelerate wind as it hits the building. A vertical axis turbine can utilise this gusting, turbulent air flow better than lift based turbines, which require smooth air flow. The fact that the air is gusting and turbulent means that it is hard to maintain efficient turbine operation. The controller overcomes much of this problem by rapidly altering the load on the turbine to ensure that it operates at its most efficient TSR.

This is particularly relevant to turbines which are drag based such as the Savoniuos turbine. Even a small change in TSR can result in a large change in efficiency. This is illustrated in FIG. 7 the drag based turbine efficiency curve 170 is much steeper than that of a lift based turbine 171. The system can react fast to alter the load on the turbine to keep the turbine operating within its optimum TSR greatly increasing the total amount of energy extracted from the wind.

The hydraulic flow generated by the hydraulic pumps may be used to power multiple hydraulic motors which power air compressors. The controller is adapted to selectively operate one or more of the hydraulic motors/compressors based upon the parameter of the turbine, such as rpm, wind speed and wind direction. This allows for the efficient operation of the turbine and efficient power matching to the compressors.

The controller may monitor the wind direction and speed, for example, to optimally load the turbine based upon the turbine tip speed to wind speed ratio by controlling the displacement of the hydraulic pumps and the combination of pumps activated and the number of devices powered. This will provide a significant increase in overall efficiency. At high wind speed, the controller will reduce the pumps displacement to protect the system from high power loads. As the wind speed/rpm increases past a maximum level, the controller reduces the displacement of all the pumps to ensure the amount of power taken from the turbine remains at a steady maximum. Additional power is thereby not captured from the turbine. Suitably, the turbine may be a vertical axis drag-based turbine which will not over speed as they can only travel as fast as the wind.

It is known for hydraulic pumps to operate most efficiently within certain boundaries. The controller should therefore utilise the number of pumps and the displacements thereof to ensure that for a given wind speed/turbine rpm they are all being used in the most efficient way possible. This would mean when a second pump is activated/loaded, the first pump would not necessarily be operating at is maximum load. However, it is more efficient to activate/load two pumps and reduce the displacement of the first to balance the load more efficiently across the two.

However, not all of the captured hydraulic force will be captured by the activated hydraulic motors/compressors. Preferably the system comprises an accumulator to capture hydraulic flow/pressure which is not being fully utilised by the currently active motors. Once the accumulated hydraulic flow/pressure is sufficient to operate the first or an additional compressor at its minimum efficient rpm, the accumulated flow/pressure is released from the accumulator and the additional compressor operates until the combined pump and accumulated flow/pressure drops to a level where the additional compressor cannot be operated at its minimum efficient rpm. The accumulator starts to accumulate hydraulic flow/pressure again. This increases efficiency by maximising the captured force. Of course, the compressors may be replaced with gas/liquid pumps, heat pumps etc., for example.

When there is not enough wind energy to efficiently power the first air compressor the energy is accumulated until there is enough accumulated energy to power the first air compressor at its efficient power for an appropriate length of time. Once the accumulated energy is used then accumulator starts to accumulate hydraulic flow/pressure again.

When a motor is operating, the controller may restrict the hydraulic flow/pressure thereto to operate the motor at its maximum efficiency. Excess hydraulic power which is accumulated can then be released to power a second motor at its maximum efficiency. This means it is more efficient to operate the two motors at maximum efficiency than one motor up to its maximum range before accumulating hydraulic power.

The accumulator will be sized accordingly to negate any loss in efficiency suffered by activating or loading an additional device which was not being powered.

Preferably the system comprises a hydraulic pump for pumping hydraulic fluid through the system, a plurality of hydraulically driven devices, at least one accumulator adapted to selectively store energy provided by said turbine, a controller for selectively storing/releasing energy from said accumulator and selectively controlling the displacement of and/or load on one or more of the plurality of hydraulically driven devices to thereby control the load on the turbine to ensure it operates within an optimum range.

Advantageously, the system may further comprise a fluid bypass adapted to selectively bypass said plurality of driven devices. Preferably, each of the plurality of driven devices and the fluid bypass may be arranged in parallel relative to each other within the system.

This provides the advantage of selectively varying the capacity of a supplied load, such as a motor, a pump or compressor, to match the currently available energy provided by, for example, wind power or water power captured by the turbine. In particular, as wind speed is constantly changing, particularly in an urban environment, an excessive energy supply that cannot be consumed by the driven device, such as a motor, pump etc., or consumer or an energy supply that is insufficient for driving the driven devices or consumer demand would be wasted, since it cannot be converted into usable work due to the physical limitations of the driven devices. The system of the present invention therefore selectively loads or unloads one or more of the driven devices to efficiently operate the turbine and match the currently available energy from the turbine thereby to maximise the usage of currently available energy and minimise waste energy. The system also protects the driven devices from operating below or above their operating limits, such as min/max rpm.

Furthermore, the accumulator allows storing any excess energy that cannot be utilized by the driven devices or consumer. For example, in the event there is insufficient energy to drive at least one driven device, all driven devices are unloaded and thereby isolated from the system and the fluid bypass is opened allowing the excess energy to be captured by the accumulator until there is sufficient energy for at least one driven device to operate efficiently. Furthermore, when one or more driven devices is already supplied by the system, but there is excess energy that may not be enough to efficiently add another driven device, the excess energy is bypassed into the accumulator via the fluid bypass until the accumulator captures enough energy to add another driven device to the system.

The hydraulic pump may be a variable displacement pump which may be directly operable through a rotational shaft of the turbine. A variable displacement pump offers the advantage of being able to rapidly and smoothly alter the load on the turbine.

Suitably a hydraulic reservoir may be located upstream of said pump and downstream of said plurality of driven devices and/or fluid bypass and may be adapted to store said hydraulic fluid received from any one or all of said plurality of driven devices and/or fluid bypass.

Preferably the turbine is a vertical axis wind turbine. The turbine may have a number of external stators used to direct the wind onto the side of the turbine rotating away from the wind. This also shields the side of the turbine which is rotating towards the wind avoiding negative torque acting against the rotation of the turbine.

Advantageously, the stators accelerate the wind flow increasing the power being generated. A vertical axis wind turbine is desirable in built-up areas typically subject to turbulent gusting winds. A vertical axis turbine is less adversely affected by this type of wind than the more conventional horizontal lift based turbine. A building will further accelerate the wind speed as the air accelerates to pass over the building.

To avoid damaging the turbine or power transfer system during high wind speeds, the system may comprise an auto-protection system. The stators on the turbine may be held in position by resilient means, such as a spring or hydraulically loaded arm, for example, to allow the same to move if an excessive wind force is applied to the stators. The stators will move and allow some air to bypass the turbine or be directed to the returning edge of the turbine thereby producing a negative torque and slowing the turbine down. Alternatively, the controller may be further adapted to selectively move the stators in accordance with the rotational speed of the turbine.

As mentioned above, the driven devices may comprise one or more of, or a combination of, an air compressor, a hydraulic pump, a heat pump for cooling or heating, and a liquid or gas pump, for example. The driven devices may comprise a plurality of hydraulic pumps which in turn power a plurality of air compressors.

Consumers often use a variable speed or variable load compressed air system. An air pressure sensor may detect when air pressure in the system has dropped to a certain level and when a demand for more compressed air is needed. Once the sensor reaches an upper limit, the system reduces the amount of compressed air being generated. The system in accordance with the present invention thereby supplements the existing infrastructure and thus will be offsetting the compressed air generated by the customers electrically driven infrastructure thereby saving them money.

The turbine will have high pressure zones caused by the accelerated air flow and the force generated by the wind to move the turbine. The location of the high pressure zones is dependent upon the direction of the wind. The controller may be further adapted to move an inlet port in the base of the turbine, or to open an inlet port within a stator, depending upon wind direction to supply accelerated/pressurised air to the intake of an air compressor. This would increase efficiency of the air compressor as it would have less work to do to compress pre-compressed air.

Where a consumer has a large cooling/refrigeration facility, the system may be used to offset their electricity used to power a refrigeration plant. The system may directly power a refrigerant compressor and heat exchangers on a standalone heat pump which will supplement the consumer's refrigeration requirement. The consumer's existing infrastructure may be thermostatically controlled so when the system is helping to keep the consumer's infrastructure cool they will be using less electricity.

Alternatively, the heat pumps may also provide heat so the system may generate heat thus offsetting the consumer's heating infrastructure.

To further increase efficiency, the external heat exchanger of the heat pump may be incorporated into the design of the turbine. A radiator of the heat exchanger may be fitted into a stator or base of a vertical axis wind turbine or the tower, nacelle or foundation of a horizontal axis wind turbine, for example. Alternatively, a fan of the heat exchanger may be directly driven by the turbine shaft or via a hydraulic system, as described above.

When a gas or liquid is being pumped, it is usually being pumped to reach a pressure or flow rate. Feedback systems may control the current electricity driven infrastructure of the consumer. The system may be used to directly drive pumps to supplement the existing infrastructure and thus reduce energy costs.

If the supplementary power is not required by the consumer, e.g. factory shut down, a control system may be used to utilise excess power to directly power an electricity generation pack. The electricity may be sold back to the grid or stored to be used to help power the system when the power is required. Alternatively, the excess hydraulic force could be accumulated and used to power the system when the power is required.

According to a second aspect of the present invention, there is provided a method of efficiently transferring the energy output of a turbine to a plurality of driven devices comprising the steps of:

determining a turbine parameter relating to the energy being generated by the turbine;

determining at least one wind parameter relating to the wind adjacent said turbine; and

selectively loading or unloading one or more of the driven devices based on at least one said turbine parameter and at least one said wind parameter to efficiently power the driven devices in accordance with the efficient power output of the turbine.

The parameter may suitably be wind speed, wind direction, turbine shaft rotational speed or torque and/or power output of the turbine.

The method may comprise the step of providing a fluid bypass to selectively isolate the driven devices.

The method may comprise the step of providing at least one accumulator for selectively storing energy within the system when the same is below a predetermined threshold.

The method may further comprise any one of the following steps:

loading one or more of the driven devices when the energy generated by the turbine is higher than the energy capacity of the loaded driven devices at a predetermined time;

loading one or more of the driven devices to ensure the devices can be operated as efficiently as possible;

storing energy when the energy in the system is too low to efficiently operate the driven devices;

storing energy within at least one accumulator when the energy in the system exceeds the energy capacity of the loaded driven devices at a predetermined time;

unloading one or more of the driven devices when the energy generated by the turbine is lower than the energy capacity of the driven devices at a predetermined time;

unloading one or more driven devices to ensure that the devices can be operated as efficiently as possible; and

loading a fluid bypass and at least one accumulator when the energy generated by the turbine is higher than the energy capacity of the loaded driven devices but lower than the energy required to drive an additional device efficiently.

The method may comprise the step of monitoring the input energy provided by the turbine operatively and/or the stored energy in the at least one accumulator.

### BRIEF DESCRIPTION OF THE DRAWINGS

A preferred embodiment of the present invention will now be described, by way of example only, with reference to the accompanying drawings, in which:

FIG. 1 shows a typical relationship between the wind speed and power output for a wind turbine comparing the power available from the wind turbine to the actual mechanical power used;

FIG. 2 shows a simplified schematic representation of power transfer system including a plurality of driven devices each adapted to drive a mechanical load;

FIG. 3 shows a hydraulic pump arrangement for a vertical axis wind turbine of a power transfer system of the present invention including a primary hydraulic pump located on one end of the turbine rotary shaft and a secondary hydraulic pump located on the other end of the turbine rotary shaft;

FIG. 4(a) shows the power output of a typical vertical axis wind turbine and the mechanical power used at a range of different wind speeds for a power transfer system of the present invention without an accumulator;

FIG. 4(b) shows a close-up view of a part of FIG. 4(a) showing the energy wastage;

FIG. 5 shows the power output of a typical vertical axis wind turbine and the mechanical power used at a range of different wind speeds for the power transfer system of the present invention with an accumulator; and

FIG. 6 shows a simplified schematic of an existing power consuming infrastructure that is supplemented with power from the power transfer system of the present invention.

FIG. 7 shows the power coefficient against tip speed ratio for different types of wind turbine.

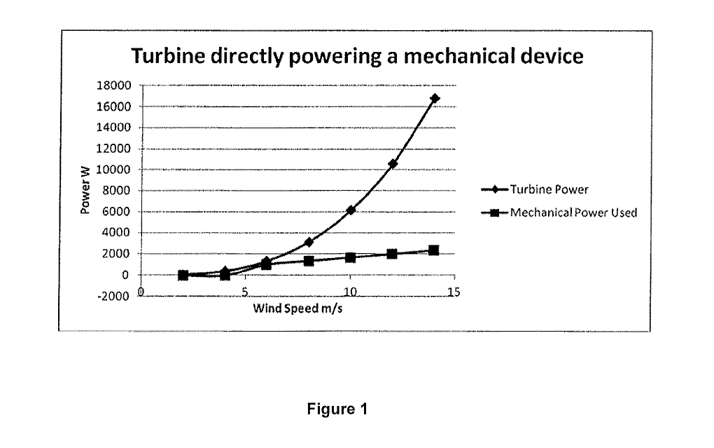

### DETAILED DESCRIPTION OF EMBODIMENTS

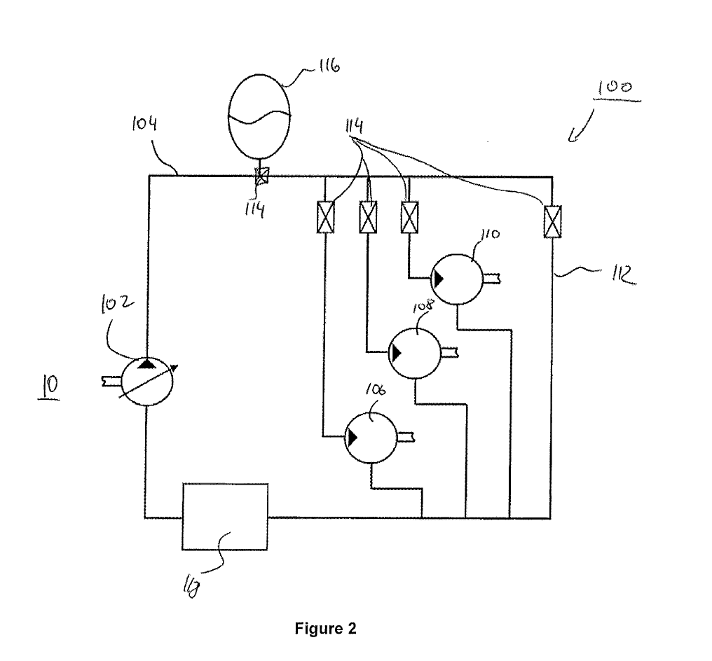

Referring to FIG. 2, at least one vertical axis wind turbine 10 is operably coupled to the power transfer system 100 of the present invention. One or more variable displacement pumps 102 are used to capture the power from the turbine 10 and transform it into a pressurized, flowing hydraulic fluid that is run through a closed loop fluid path 104 in order to provide power to various loads. The hydraulic fluid displacement of the one or more variable displacement pumps 102 is determined by the current wind speed which moves the turbine's rotary shaft that is directly coupled to the one or more variable displacement pumps 102. The one or more variable displacement pumps 102 are configured to capture the maximum available power provided by the turbine 10. A pump controller (not shown) monitors the parameters relating to the energy output of the turbine such as wind speed, wind direction, shaft speed or torque and selectively controls the number of variable displacement pumps 102 that are required to efficiently capture the available power at any one time.

A plurality of selectively driveable devices 106, 108, 110 are operably coupled to the closed loop fluid path 104 so that the hydraulic fluid can selectively drive any number or all of the plurality of energy transformers 106, 108, 110. In this particular embodiment, the devices 106, 108, 110 are hydraulic fluid driven motors that may be coupled to a mechanical load such as a compressor. Also, the devices 106, 108, 110 are each connected in parallel to the closed loop fluid path 104, therefore allowing the hydraulic fluid to drive each of the plurality of devices 106, 108, 110 separately or in combination with any number of devices 106, 108, 110.

A fluid bypass 112 is provided within the closed loop fluid path 104 so that the power transmission system can run in an idle mode allowing the hydraulic fluid to simply return to the displacement pump 102 without performing any substantial work in any of the devices 106, 108, 110.

Each of the devices 106, 108, 110 and the fluid bypass 112 are connected within the closed loop fluid path 104 via a selectively actuated control valve 114, wherein each one of the control valves 114 is controlled by a power controller (not shown). For example, the power controller (not shown) can actuate any one of the control valves to allow hydraulic fluid to flow via any one of the devices 106, 108, 110 and/or the fluid bypass 112. Furthermore, the power controller (not shown) is adapted to monitor the currently available energy provided by the one or more variable displacement pumps 102. For example, the power controller (not shown) may monitor the rotational speed of the turbine rotary shaft, torque of the turbine shaft, the hydraulic fluid flow speed or pressure within the closed loop fluid path 104 and the wind speed. In accordance to the current wind speed or available energy, the power controller (not shown) then actuates any one of the control valves 114 to match the utilized load (i.e. driven devices) 106, 108, 110 with the currently available energy. The pump controller (not shown) may be an integral part of the power controller, so that one control mechanism controls the number of utilized variable displacement pumps 102 and the number of loads (i.e. driven devices) 106, 108, 110.

In addition, the power transfer system 100 comprises a selectively utilizable accumulator 116. The accumulator 116 is in fluid communication with the closed loop fluid path 104 of the power transfer system 100 via one of the selectively actuated control valves 114, so that the power controller (not shown) can selectively actuate the control valve 114 to either close or open fluid communication between the accumulator 116 and the closed loop fluid path 104. Preferably, the accumulator 116 is located downstream of the one or more variable displacement pumps 102, but upstream of any one of the plurality of devices 106, 108, 110 and the fluid bypass 112.

A reservoir 118 is located upstream of the one or more variable displacement pumps 102 allowing hydraulic return fluid to be stored and provided to the one or more displacement pumps 102 according to demand.

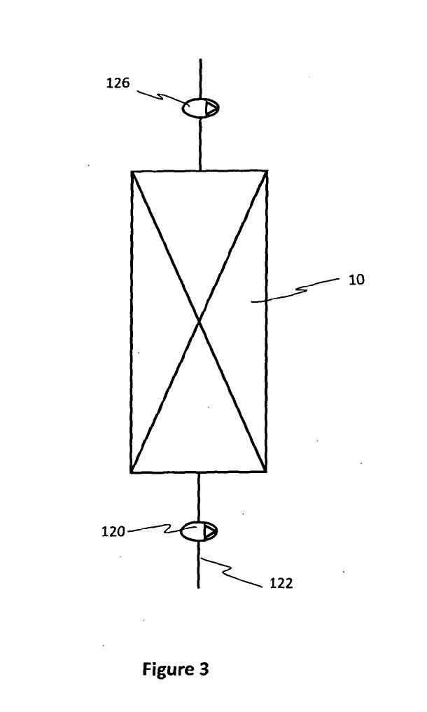

FIG. 3 shows an example of a variable displacement pump arrangement within the power transfer system (not shown). In particular, a primary hydraulic variable displacement pump 120 is operably coupled to one end of the rotary shaft 122 of a vertical axis wind turbine 10 and a secondary hydraulic variable displacement pump 126 is operably coupled to another end of the rotary shaft 122 of the vertical axis wind turbine 10. In operation, when the wind speed is low, the primary hydraulic variable displacement pump 122 is used to capture power from the turbine 10. As the air speed increases, the turbine shaft speed increases the pump control (not shown) will increase the pump displacement to efficiently extract power from the turbine. At this stage the secondary hydraulic variable displacement pump 126 is not under full load and the hydraulic fluid is allowed to freely return to the reservoir 118 (as referred to in FIG. 2). Alternatively, the secondary pump 126 may be disengaged from the turbine via a clutch arrangement (not shown). Once the shaft speed reaches a predetermined speed and the power generated by the turbine 10 has reached a certain level to efficiently load both pumps, the secondary pump 126 is utilised to run hydraulic fluid into the closed loop fluid path 104. Of course, the turbine may be selectively coupled with multiple pumps instead via a gearbox or through drive and which may be isolated/unloaded by a bypass, corresponding bypass valves and/or clutch arrangements.

(i) Operation at Low Wind Power

At low wind speed, the turbine 10 is not generating enough power to drive at least one of the plurality of devices 106, 108, 110. The power controller (not shown) actuates control valves 114 to stop hydraulic fluid flow to pass through any of the devices 106, 108, 110 and the fluid bypass 112 and opens the hydraulic fluid flow into the accumulator 116.

The energy stored in the accumulator 116 is monitored by the power controller (not shown). As soon as the accumulators energy level is sufficient to drive at least one of the devices 106, 108, 110 for a predetermined minimum time period at maximum efficiency, the power controller actuated control valves 114 to allow fluid flow through, for example, device 106.

(ii) Operation at Sufficient Wind Power

At sufficiently high wind speeds, at least one of the devices 106, 108, 110 is driven by the hydraulic fluid. The power controller controls the hydraulic fluid flow to the device 106 so that the device 106 and its mechanical load (—e.g. compressor) operate within an optimal range. If the available energy increases (i.e. wind speed increases) to a level that does not allow driving another device 108, the excess energy is stored in the accumulator 116. When the accumulated energy reaches a level that allows driving a second device 108 and first device 106 at their optimal ranges, the power controller actuates control valve 114 to allow hydraulic fluid to flow from the variable displacement pumps 102 and the accumulator 116 to the second device 108 until the available energy drops below the required minimum energy level, at which point the power controller closes the control valve 114 to device 108 and opens control valve 114 to accumulator 116 to allow excess energy to be stored. Using the accumulator 116, may also smooth out any energy pulsations caused by the highly variable power output of the wind turbine 10 and allows the powered devices to be operated at their most efficient speeds.

The above steps are applied for any number of devices 106, 108, 110 required to utilize any amount of energy provided by the wind turbine 10. Therefore, although the example describes three devices 106, 108, 110 (i.e. loads), any number of loads may be used with the power transmission system 100 of the present invention. The controller may be programmed with the performance characteristics of the devices so it can operate them as efficiently as possible.

In addition, to minimise periods between maintenance, the power controller (not shown) could swap the functionality of devices 106, 108, 110 in such a way which would even out the work load on each device 106, 108, 110 and its mechanical load. The devices may not necessarily be identical and they may have different performance characteristics. The controller will take this into account when evening out the work load. The power controller may be adapted to detect problems with pumps, motors or other devices, isolating the potentially faulty device from the rest of the power transfer system 100 and run the remaining equipment as efficiently as possible. For example, device 108 or its mechanical load may develop a fault. The power controller would detect the fault and not use the device 108. The power controller may provide a report and send the information to a remote user.

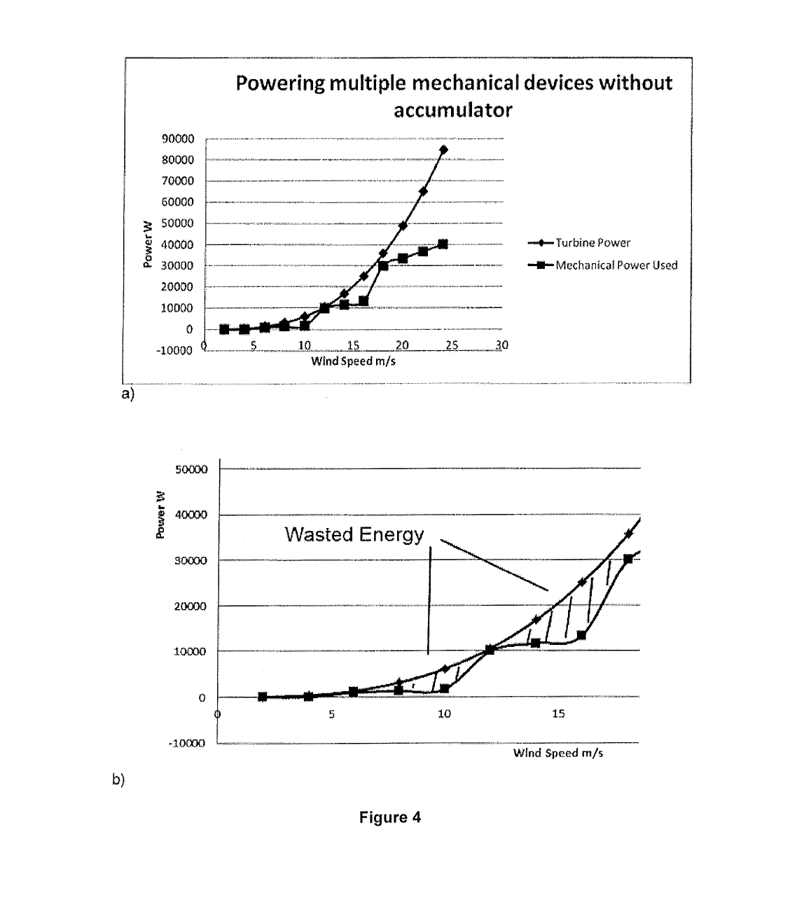

FIG. 4(a) shows the utilized mechanical power compared to the power available from the turbine 10 of the power transfer system 100 without using an accumulator 116 to capture excess or insufficient energy. It is clear from the graph that the utilized power matches the available power more closely. FIG. 4(b) shows the convergence of the utilized power in more detail. Parameters of the wind (wind speed and wind direction) are measured using wind parameter measuring device 161. Turbine parameters (shaft speed and torque) are measured directly from the shaft. The turbine parameters are used to determine the turbine blade tip speed. These parameters are compared to to ensure that the tip speed to wind speed ratio provides the most efficient capture of energy from the available wind by varying the load on the shaft 122 by selectively coupling driveable devices 106, 108 and 110.

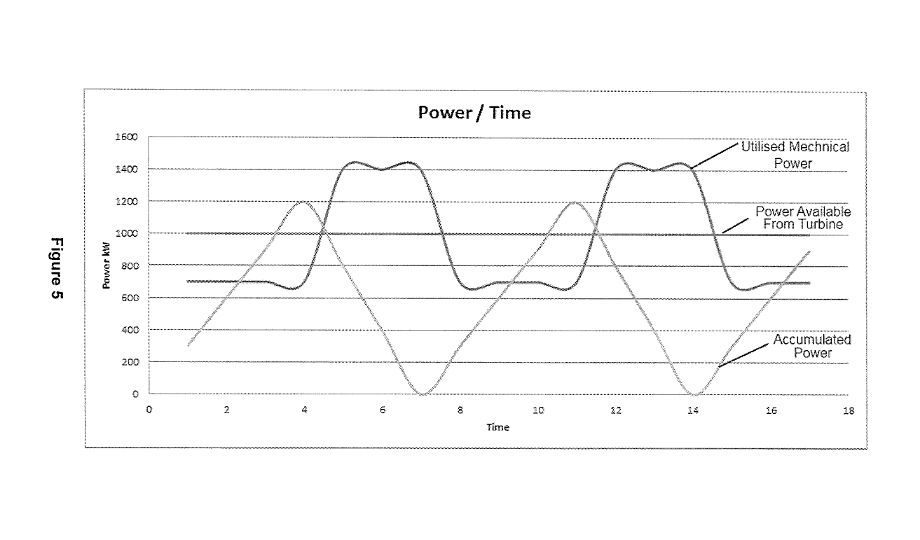

FIG. 5 shows the utilized mechanical power compared to the power available from the turbine 10 of the power transfer system 100 using an accumulator 116 to capture any excess or insufficient energy.

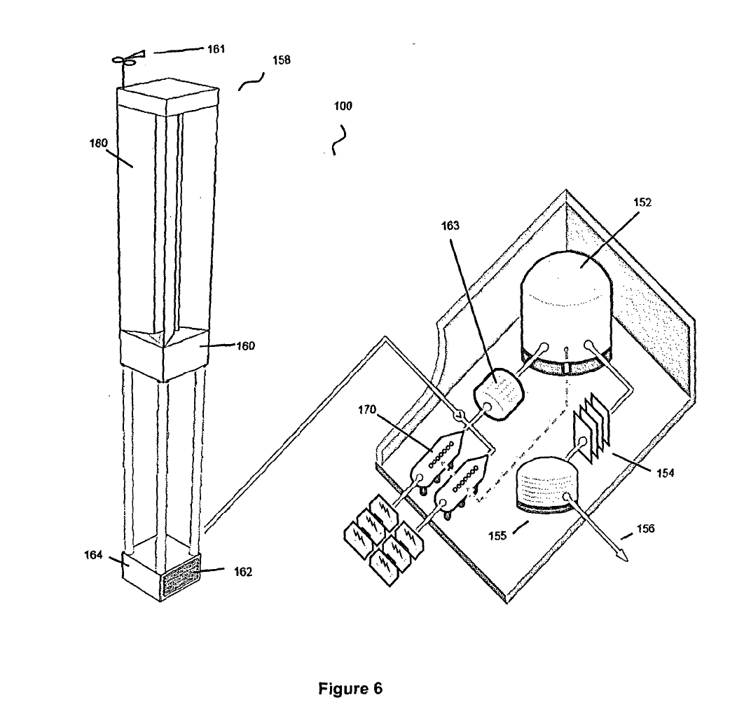

FIG. 6 shows the power transfer system 100 of the present invention applied such as to supplement the power requirements of an existing infrastructure. For example, the power transfer system 100 may convert wind power into compressed air that is stored in a pressure tank 152 and supplied via a filter 154 and dryer 155 to supplement the compressed air 156 used in an existing infrastructure. A controller and feedback mechanism ensure that the compressed air demand is met by the supplemented compressed air from the power transfer system 100 of the present invention and/or the compressors of the existing infrastructure. A turbine 158 may comprise a hydraulic pump 160 to hydraulically power an air compressor 162. The compressor 162 in turn compresses air to be cooled by a cooler 163 and stored in the tank 152. The standard electricity generating compressors 170 will vary their output to keep the tank 152 at the desired pressure. A wind measurement device 161 is used in conjunction with the control system 164 and other parameters to make sure the load on the turbine is rapidly altered to keep it operating within its most efficient TSR. Wind measurement device 161 measures at least wind speed and preferably also measures wind direction. The wind speed is used to ensure that the tip speed to wind speed ratio (with tip speed derived from the speed of rotation of shaft 122) is maintained at the correct ratio (generally about 0.8) by varying the load applied to the shaft 122 as described above. It should be noted that this ratio may vary with wind speed and may also vary with wind direction (if the turbine 158 is located close to a building).

The turbine 158 has a number of external stators 180 which direct the wind onto the side of the turbine rotating away from the wind. This also shields the side of the turbine which is rotating towards the wind avoiding negative torque acting against the rotation of the turbine. Advantageously, the stators 180 accelerate the wind flow increasing the power being generated. To avoid damaging the turbine or power transfer system during high wind speeds, the stators 180 may be held in position by resilient means (not shown), such as a spring or hydraulically loaded arm, for example, to allow the same to move if an excessive wind force is applied to the stators. The stators will move and allow some air to bypass the turbine or be directed to the returning edge of the turbine thereby producing a negative torque and slowing the turbine down. Alternatively, a controller may selectively move the stators in accordance with the rotational speed of the turbine.

(iii) Specific Example When Used with an Existing Infrastructure

A direct drive may be used to power multiple air compressors. So the rotational movement of the wind turbine is directly used to drive a compressor pump to generate compressed air. They can be connected serially to the turbine via a through drive shaft or independently via a multi gearbox or a combination of the two. In the case of a through drive the air compressors have an input shaft and through drive output shaft. The multiple compressors are serially connected in line from the first compressor to the last compressor via shaft couplings. In a multi gear box system then multiple compressors are powered by the multi gear box and could also be connected to other compressors via a through drive. The compressors all have bypass valves which allow them to vent the compressed air straight to the atmosphere and thus take minimal power form the turbine. At the start, all compressors vent to air. A control system may be used to sense the turbine's rotational speed, torque, wind speed and wind direction. As the turbine reaches the minimum rotational speed, the first compressor stops venting to air and starts to supply compressed air to the existing infrastructure. When the required rotational speed is reached, the additional compressors also start to supply compressed air to the existing infrastructure. As the turbine rotational speed decreases, the control system starts to unload the last compressors first until only the first compressor is operating. If the rotational speed drops below a predetermined minimum, the first compressor is unloaded. This allows the load to be increased as the torque generated by the turbine increases with wind speed.

However even when a compressor is venting to air and unloaded it still uses 10% of its operational power requirements, which means that the turbine operates inefficiently at lower wind speeds. Therefore, a clutch system may be used to completely disengaged some of the compressors from the turbine.

Instead of the above described direct drive, the hydraulic power transmission system 100 may be used to drive the compressor pumps and generate compressed air for the existing infrastructure.

Hydraulic pumps may have a bypass valve which means they can operate unloaded or partially loaded. They may also have through drive systems, allowing multiple configurations and/or a clutch arrangement.

This example has been for compressed air, but may also be applied to heat pumps, gas and liquid pumps or powering electricity generator.

The turbine may have high pressure zones caused by the accelerated air flow and the force generated by the wind to move the turbine. The location of the high pressure zones may be dependent upon the direction of the wind. A control system may be used to move an inlet port in the base of the turbine or in the stators depending upon wind direction to supply accelerated/pressurised air to the intake of, for example, an air compressor. This may further increase efficiency of the air compressor, because less work is required to compress the pre-compressed air.

It will be appreciated by persons skilled in the art that the above embodiment has been described by way of example only and not in any limitative sense, and that various alterations and modifications are possible without departing from the scope of the invention as defined by the appended claims.

1. A power transfer system comprising:
a turbine for capturing wind energy;
a wind parameter measuring device for measuring at least one parameter of the wind adjacent said turbine;
at least one driven device coupleable to the turbine to be driven thereby; and
a controller adapted to monitor at least one turbine parameter relating to the energy output of the turbine and selectively load or unload one or more of the plurality of driven devices based on at least one said turbine parameter and at least one said wind parameter to maximise the efficiency of the turbine and the efficient power transfer from the turbine to one or more of the driven devices.

2. (canceled)

3. A system according to claim 1, wherein the driven devices are directly or indirectly coupleable to the turbine.

4. A system according to claim 1 comprising a disengager to selectively disengage one or more driven devices from the turbine.

5. A system according to claim 4 comprising a clutch to selectively disengage one or more driven devices from the turbine.

6. A system according to claim 1 comprising a bypass so that the drive from the turbine selectively bypasses one or more driven devices to unload the same.

7-13. (canceled)

14. A system according to claim 1 comprising a closed loop for hydraulic fluid to flow, a hydraulic pump for pumping hydraulic fluid through the system, at least one accumulator adapted to selectively store energy provided by said turbine, wherein the plurality of driven devices are hydraulically driven devices and wherein the controller is adapted to selectively store/release energy from said accumulator and selectively control the displacement of and/or load on one or more of the plurality of hydraulically driven devices to thereby control the load on the turbine to ensure it operates within an optimum range.

15. A system according to claim 14 further comprising a fluid bypass adapted to selectively bypass said plurality of driven devices.

16-19. (canceled)

20. A system according to claim 1 wherein the turbine is a vertical axis wind turbine.

21. A system according to claim 20 wherein the turbine comprises a plurality of external stators for directing wind onto a side of the turbine rotating away from the wind.

22. A system according to claim 21 wherein the stators are held in position by a resilient retainer to allow the same to move if an excessive wind force is applied to the stators.

23. A system according to claim 22 wherein the controller is further adapted to selectively move the stators in accordance with the rotational speed of the turbine.

24. A system according to claim 1 wherein the controller is further adapted to move an inlet port in the base of the turbine or open an inlet port in a stator of the turbine depending upon wind direction to supply accelerated/pressurised air to the intake of an air compressor.

25. A system according to claim 1 wherein at least one said wind parameter comprises at least one of wind speed and wind direction.

26. (canceled)

27. (canceled)

28. A system according to claim 1 wherein said turbine rotates about a vertical axis.

29. A method for efficiently operating a turbine and efficiently transferring the energy output of a turbine to a plurality of driven devices of a power transfer system, comprising the steps of
determining a turbine parameter relating to the energy being generated by the turbine;
determining at least one wind parameter relating to the wind adjacent said turbine; and
selectively loading or unloading one or more of the driven devices based on at least one said turbine parameter and at least one said wind parameter to efficiently power the driven devices in accordance with the efficient power output of the turbine.

30. A method according to claim 29 wherein the power transfer system comprises a hydraulic closed loop and the method comprises the step of providing a hydraulic fluid bypass to selectively isolate the driven devices.

31. A method according to claim 29 wherein the method comprises the step of providing at least one accumulator for selectively storing energy within the system when the same is below a predetermined threshold.

32. (canceled)

33. A method according to claim 29 comprising any one of the following steps:
loading one or more of the driven devices when the energy generated by the turbine is higher than the energy capacity of the loaded driven devices at a predetermined time;
loading one or more of the driven devices to ensure the devices can be operated as efficiently as possible;
storing energy within at least one accumulator when the energy in the system exceeds the energy capacity of the loaded driven devices at a predetermined time;
unloading one or more of the driven devices when the energy generated by the turbine is lower than the energy capacity of the driven devices at a predetermined time;
unloading one or more driven devices to ensure that the devices can be operated as efficiently as possible; and
loading a fluid bypass and at least one accumulator when the energy generated by the turbine is higher than the energy capacity of the loaded driven devices but lower than the energy required to drive an additional device efficiently.

34. A method according to claim 29 wherein at least one said wind parameter comprises at least one of wind speed and wind direction.

35. A method according to claim 29 wherein at least one said turbine parameter comprises turbine rotational speed.

36. (canceled)

37. (canceled)
